(19) United States
(12) Patent Application Publication
(10) Pub. No.: US 2025/0379001 A1
(43) Pub. Date: Dec. 11, 2025

(54) CAPACITOR

(71) Applicant: Panasonic Intellectual Property Management Co., Ltd., Osaka (JP)

(72) Inventors: KENICHI ASANUMA, Osaka (JP); MASAYUKI SATO, Saga (JP); TAKASHI KAWASAKI, Osaka (JP); YUKI UEDA, Osaka (JP); KOJI TAKAHASHI, Kanagawa (JP)

(21) Appl. No.: 18/997,554

(22) PCT Filed: Sep. 7, 2023
(86) PCT No.: PCT/JP2023/032653

§ 371 Date: Jan. 22, 2025

(30) Foreign Application Priority Data
Sep. 28, 2022 (JP) 2022-155343

(51) Int. Cl. H01G 9/012; H01G 9/08; H01G 9/26

(52) U.S. Cl. CPC H01G 9/012; H01G 9/08; H01G 9/26

(57) ABSTRACT

A capacitor includes a first capacitor element, a second capacitor element, a first anode terminal plate, a second anode terminal plate, a first cathode terminal plate, a second cathode terminal plate, and a resin part. The second capacitor element is adjacent to the first capacitor element in a second direction orthogonal to a first direction. The first capacitor element includes a first outer lead part of a first anode lead and a first cathode that are disposed side by side in this order in the first direction. The second capacitor element includes a second cathode and a second outer lead part of a second anode lead that are disposed side by side in this order in the first direction. The first outer lead part overlaps the second cathode at side view in the second direction. The second outer lead part overlaps the first cathode at the side view.

### TECHNICAL FIELD

The present disclosure relates generally to a capacitor, and more particularly to a capacitor including a plurality of capacitor elements.

### BACKGROUND ART

As a capacitor, a decoupling device has been conventionally known, the decoupling device including a first capacitor element, a second capacitor element, a pair of anode terminals, a cathode terminal, and a resin layer (resin part) (PTL 1). The first capacitor element includes an anode body (first anode), an anode part (first anode lead), a dielectric layer (first dielectric layer), and a cathode part (first cathode). The second capacitor element includes an anode body (second anode), an anode part (second anode lead), a dielectric layer (second dielectric layer), and a cathode part (second cathode).

### CITATION LIST

### Patent Literature

PTL 1: International Publication No. WO 2010/023990

### SUMMARY OF THE INVENTION

A capacitor according to an aspect of the present disclosure includes a first capacitor element, a second capacitor element, a first anode terminal plate, a second anode terminal plate, a first cathode terminal plate, a second cathode terminal plate, and a resin part. The first capacitor element includes a first anode, a first dielectric layer, a first cathode, and a first anode lead. The first anode includes a first end surface and a second end surface that are separated from each other in a first direction, and an outer peripheral surface. The first dielectric layer covers the first end surface of the first anode, the second end surface of the first anode, and the outer peripheral surface of the first anode. The first cathode covers the first dielectric layer. The first anode lead includes a first outer lead part protruding from the first end surface of the first anode. The second capacitor element is adjacent to the first capacitor element in a second direction orthogonal to the first direction. The second capacitor element includes a second anode, a second dielectric layer, a second cathode, and a second anode lead. The second anode includes a first end surface and a second end surface that are separated from each other in the first direction, and an outer peripheral surface. The second dielectric layer covers the first end surface of the second anode, the second end surface of the second anode, and the outer peripheral surface of the second anode. The second cathode covers the second dielectric layer. The second anode lead includes a second outer lead part protruding from the first end surface of the second anode. The first anode terminal plate includes a first anode terminal. The first anode terminal plate is connected to the first outer lead part. The second anode terminal plate includes a second anode terminal. The second anode terminal plate is connected to the second outer lead part. The first cathode terminal plate includes a first cathode terminal. The first cathode terminal plate is connected to the first cathode. The second cathode terminal plate includes a second cathode terminal. The second cathode terminal plate is connected to the second cathode. The resin part covers the first capacitor element and the second capacitor element. The resin part exposes the first anode terminal, the second anode terminal, the first cathode terminal, and the second cathode terminal. In the first capacitor element, the first outer lead part and the first cathode are disposed side by side in this order in the first direction. In the second capacitor element, the second cathode and the second outer lead part are disposed side by side in this order in the first direction. The first outer lead part overlaps the second cathode at side view in the second direction. The second outer lead part overlaps the first cathode at the side view.

The capacitor according to the aspect of the present disclosure can achieve low ESL and downsizing.

### BRIEF DESCRIPTION OF THE DRAWINGS

FIG. 1 is a perspective view illustrating a capacitor according to a first exemplary embodiment.

FIG. 2 is a front view illustrating the capacitor according to the first exemplary embodiment.

FIG. 3 is a plan view illustrating the capacitor according to the first exemplary embodiment.

FIG. 4 is a bottom view illustrating the capacitor according to the first exemplary embodiment.

FIG. 5 is a side view illustrating the capacitor according to the first exemplary embodiment.

FIG. 6 is a sectional view illustrating the capacitor according to the first exemplary embodiment taken along line Y1-Y1 in FIG. 3.

FIG. 7 is a sectional view illustrating the capacitor according to the first exemplary embodiment taken along line Y2-Y2 in FIG. 3.

FIG. 8 is a sectional view illustrating the capacitor according to the first exemplary embodiment taken along line X1-X1 in FIG. 3.

FIGS. 9A to 9C are each an explanatory diagram of a method for manufacturing the capacitor according to the first exemplary embodiment.

FIG. 10 is an operation explanatory diagram of the capacitor according to the first exemplary embodiment.

FIG. 11 is a front view illustrating a capacitor according to a first modification of the first exemplary embodiment.

FIG. 12 is a perspective view illustrating a capacitor according to a second modification of the first exemplary embodiment.

FIG. 13 is a front view illustrating the capacitor according to the second modification of the first exemplary embodiment.

FIG. 14 is a plan view illustrating a capacitor according to a third modification of the first exemplary embodiment.

FIG. 15 is a bottom view illustrating the capacitor according to the third modification of the first exemplary embodiment.

FIG. 16 is a front view illustrating the capacitor according to the third modification of the first exemplary embodiment.

FIG. 17 is a plan view illustrating a capacitor according to a second exemplary embodiment.

FIG. 18 is a bottom view illustrating the capacitor according to the second exemplary embodiment.

FIG. 19 is a plan view illustrating a capacitor according to a third exemplary embodiment.

FIG. 20 is a bottom view illustrating the capacitor according to the third exemplary embodiment.

FIG. 21 is a sectional view illustrating the capacitor according to the third exemplary embodiment taken along line X1-X1 in FIG. 19.

FIG. 22 is a sectional view illustrating the capacitor according to the third exemplary embodiment taken along line X2-X2 in FIG. 19.

FIG. 23 is a sectional view illustrating the capacitor according to the third exemplary embodiment taken along line X3-X3 in FIG. 19.

FIG. 24 is a bottom view illustrating a capacitor according to a fourth modification of the first exemplary embodiment.

FIG. 25 is a bottom view illustrating a capacitor according to a fifth modification of the first exemplary embodiment.

FIG. 26 is a bottom view illustrating a capacitor according to a sixth modification of the first exemplary embodiment.

FIG. 27 is a front view illustrating a capacitor according to a seventh modification of the first exemplary embodiment.

FIG. 28 is a front view illustrating a capacitor according to an eighth modification of the first exemplary embodiment.

FIG. 29 is a front view illustrating a capacitor according to a ninth modification of the first exemplary embodiment.

### DESCRIPTION OF EMBODIMENT

Capacitors may be required to be not only reduced in equivalent series inductance (ESL), but also downsized. The present disclosure provides a capacitor capable of achieving low ESL and downsizing.

Each of drawings described in exemplary embodiments below is merely a schematic diagram, and a ratio of each of size and thickness of each component in the drawing does not necessarily reflect an actual dimensional ratio.

### First Exemplary Embodiment

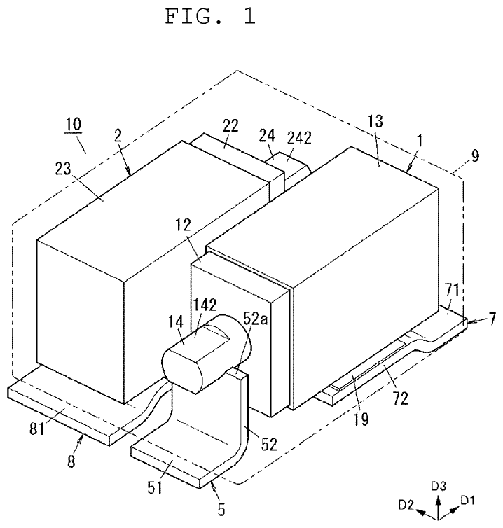

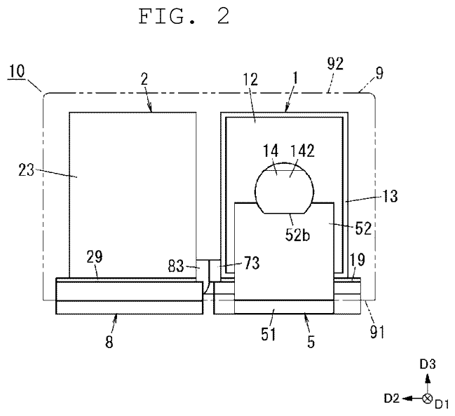

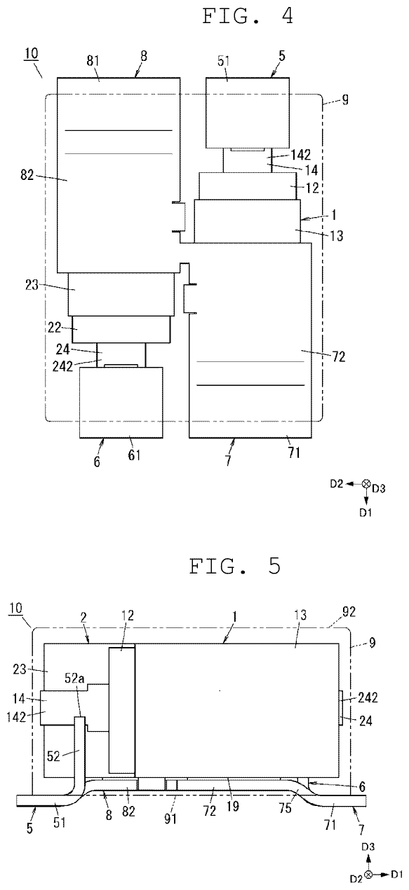

Hereinafter, capacitor 10 according to a first exemplary embodiment will be described with reference to FIGS. 1 to 10.

### (1) Outline

As illustrated in FIGS. 1 to 5, capacitor 10 according to the first exemplary embodiment includes first capacitor element 1 and second capacitor element 2. Capacitor 10 is a surface-mount electrolytic capacitor, for example, and includes first anode terminal plate 5, second anode terminal plate 6, first cathode terminal plate 7, and second cathode terminal plate 8 as a plurality of external terminals to be mounted on a circuit board such as a motherboard. First anode terminal plate 5, second anode terminal plate 6, first cathode terminal plate 7, and second cathode terminal plate 8 are joined to the circuit board by soldering or the like.

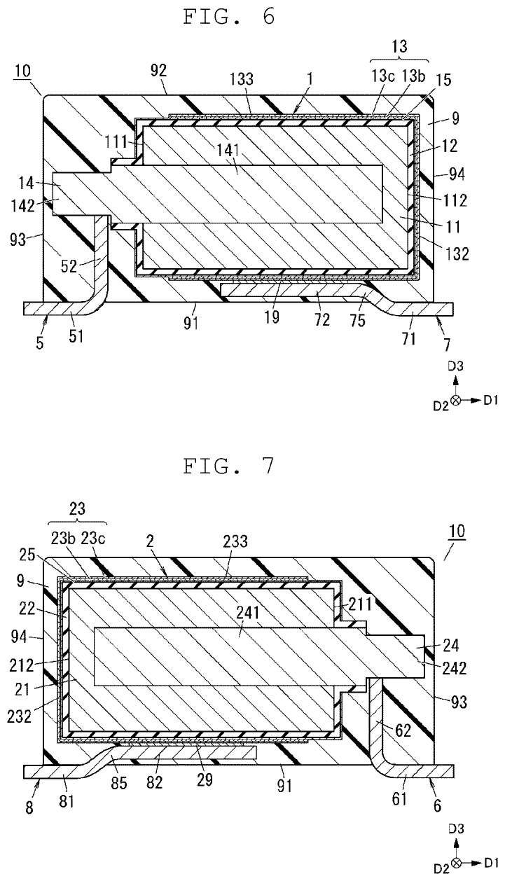

First capacitor element 1 is a solid electrolytic capacitor, and includes first anode lead 14 and first cathode 13. Second capacitor element 2 is a solid electrolytic capacitor, and includes second anode lead 24 and second cathode 23. Capacitor 10 includes first capacitor element 1 with first anode lead 14 connected to first anode terminal plate 5, and with first cathode 13 connected to first cathode terminal plate 7. Capacitor 10 also includes second capacitor element 2 with second anode lead 24 connected to second anode terminal plate 6, and with second cathode 23 connected to second cathode terminal plate 8. Resin part 9 is provided covering first capacitor element 1 and second capacitor element 2. As illustrated in FIGS. 6 to 8, resin part 9 exposes a part of first anode terminal plate 5, a part of second anode terminal plate 6, a part of first cathode terminal plate 7, and a part of second cathode terminal plate 8.

### (2) Details

With reference to FIGS. 1 to 10, a configuration of capacitor 10 according to the first exemplary embodiment will be described in detail.

As illustrated in FIGS. 1 to 8, capacitor 10 includes first capacitor element 1, second capacitor element 2, first anode terminal plate 5, second anode terminal plate 6, first cathode terminal plate 7, second cathode terminal plate 8, and resin part 9.

### (2.1) First Capacitor Element

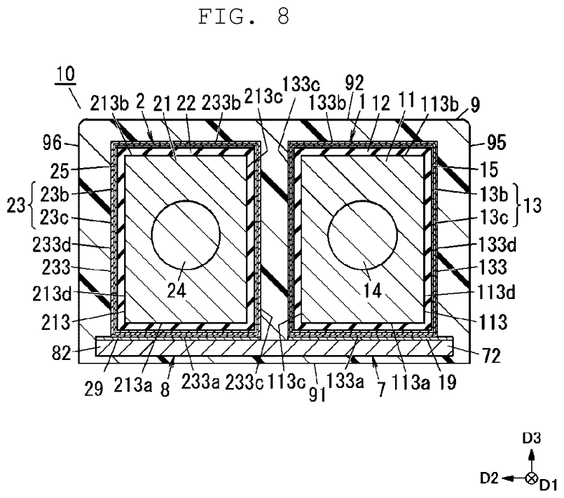

As illustrated in FIGS. 6 and 8, first capacitor element 1 includes first anode (first anode body) 11, first dielectric layer 12, first solid electrolyte layer 15, first cathode 13, and first anode lead 14. First solid electrolyte layer 15 is not illustrated in FIGS. 1 to 5 and the like.

First anode 11 has conductivity. Examples of a material of first anode 11 include tantalum. The material of first anode 11 is not limited to the tantalum, and may be aluminum, niobium, titanium, zirconium, or hafnium, or may be an alloy containing one or more kinds of metal selected from a group consisting of tantalum, aluminum, niobium, titanium, zirconium, and hafnium, for example.

First anode 11 has a rectangular parallelepiped shape, and includes first end surface 111 and second end surface 112 that are separated from each other in first direction D1, and outer peripheral surface 113. Outer peripheral surface 113 includes four side surfaces 113a to 113d (hereinafter, also referred to as first side surface 113a, second side surface 113b, third side surface 113c, and fourth side surface 113d) connecting an outer edge of first end surface 111 and an outer edge of second end surface 112, for example, without including first end surface 111 and second end surface 112. First anode 11 is a porous body containing a valve metal, for example, and is more specifically a porous sintered body containing tantalum. First anode 11 is not limited to the porous sintered body, and may be metal foil with a porous surface part, for example.

First dielectric layer 12 is provided covering first end surface 111, second end surface 112, and outer peripheral surface 113 of first anode 11. More specifically, first dielectric layer 12 is provided covering a porous surface constituting first anode 11. Examples of a material of first dielectric layer 12 include tantalum oxide. First dielectric layer 12 can be formed by performing anodic oxidation on first anode 11, for example. The material of first dielectric layer 12 is not limited to the tantalum oxide, and may be aluminum oxide, niobium oxide, titanium oxide, zirconium oxide, or hafnium oxide, for example. First dielectric layer 12 is formed along the porous surface constituting first anode 11.

First solid electrolyte layer 15 is provided covering first dielectric layer 12. Examples of a material of first solid electrolyte layer 15 include a conductive polymer. Available examples of the conductive polymer include polypyrrole, polythiophene, polyaniline, and derivatives thereof. The material of first solid electrolyte layer 15 is not limited to the conductive polymer, and may be a manganese compound, for example.

First cathode 13 is provided covering first solid electrolyte layer 15. That is, first cathode 13 is provided covering first dielectric layer 12 with first solid electrolyte layer 15 interposed therebetween. First cathode 13 includes first conductive layer 13b covering first solid electrolyte layer 15, and first cathode layer 13c covering first conductive layer 13b, for example.

First conductive layer 13b is a carbon layer having conductivity, for example. The carbon layer having conductivity contains a conductive carbon material such as graphite, for example.

First cathode layer 13c contains metal (e.g., silver) and resin, for example. First cathode layer 13c is formed using a conductive paste (e.g., silver paste).

First cathode 13 includes end surface 132 overlying second end surface 112 of first anode 11 in first direction D1, and outer peripheral surface 133. Outer peripheral surface 133 of first cathode 13 includes first side surface 133a facing first cathode terminal plate 7, second side surface 133b parallel to first side surface 133a, third side surface 133c facing second capacitor element 2, and fourth side surface 133d parallel to third side surface 133c. First side surface 133a is provided along first side surface 113a of first anode 11. Second side surface 133b is provided along second side surface 113b of first anode 11. Third side surface 133c is provided along third side surface 113c of first anode 11. Fourth side surface 133d is provided along fourth side surface 113d of first anode 11.

First anode lead 14 is made of metal. First anode lead 14 may be made of a material identical to or different from that of first anode 11. First anode lead 14 includes first inner lead part 141 embedded in first anode 11 and first outer lead part 142 protruding from first end surface 111 of first anode 11. First anode lead 14 has a wire shape with a circular shape in section orthogonal to first direction D1.

### (2.2) Second Capacitor Element

As illustrated in FIGS. 7 and 8, second capacitor element 2 is adjacent to first capacitor element 1 in second direction D2 orthogonal to first direction D1. In other words, second capacitor element 2 is disposed aligned with first capacitor element 1 in second direction D2.

Second capacitor element 2 includes second anode (second anode body) 21, second dielectric layer 22, second solid electrolyte layer 25, second cathode 23, and second anode lead 24. Second solid electrolyte layer 25 is not illustrated in FIGS. 1, 3 and 4, and the like.

Second anode 21 has conductivity. Second anode 21 is made of a material identical to that of first anode 11.

Second anode 21 includes first end surface 211 and second end surface 212 that are separated from each other in first direction D1, and outer peripheral surface 213. Outer peripheral surface 213 includes four side surfaces 213a to 213d (hereinafter, also referred to as first side surface 213a, second side surface 213b, third side surface 213c, and fourth side surface 213d) connecting an outer edge of first end surface 211 and an outer edge of second end surface 212, for example, without including first end surface 211 and second end surface 212. Second anode 21 is a porous body containing a valve metal, for example, and is more specifically a porous sintered body containing tantalum. Second anode 21 is not limited to the porous sintered body, and may be metal foil with a porous surface part, for example.

Second dielectric layer 22 is provided covering first end surface 211, second end surface 212, and outer peripheral surface 213 of second anode 21. More specifically, second dielectric layer 22 is provided covering a porous surface constituting second anode 21. Second dielectric layer 22 is made of a material identical to that of first dielectric layer 12.

Second solid electrolyte layer 25 is provided covering second dielectric layer 22. Second solid electrolyte layer 25 is made of a material identical to that of first solid electrolyte layer 15.

Second cathode 23 is provided covering second solid electrolyte layer 25. That is, second cathode 23 is provided covering second dielectric layer 22 with second solid electrolyte layer 25 interposed therebetween. Second cathode 23 includes second conductive layer 23b covering second solid electrolyte layer 25, and second cathode layer 23c covering second conductive layer 23b, for example.

Second conductive layer 23b is a carbon layer having conductivity, for example. The carbon layer having conductivity contains a conductive carbon material such as graphite, for example. Second conductive layer 23b is made of a material identical to that of first conductive layer 13b.

Second cathode layer 23c contains metal (e.g., silver) and resin, for example. Second cathode layer 23c is formed using a conductive paste (e.g., silver paste). Second cathode layer 23c is made of a material identical to that of first cathode layer 13c.

Second cathode 23 includes end surface 232 overlying second end surface 112 of second anode 21 in first direction D1, and outer peripheral surface 233. Outer peripheral surface 233 of second cathode 23 includes first side surface 233a facing second cathode terminal plate 8, second side surface 233b parallel to first side surface 233a, third side surface 233c facing first capacitor element 1, and fourth side surface 233d parallel to third side surface 233c. First side surface 233a is provided along first side surface 213a of second anode 21. Second side surface 233b is provided along second side surface 213b of second anode 21. Third side surface 233c is provided along third side surface 213c of second anode 21. Fourth side surface 233d is provided along fourth side surface 213d of second anode 21.

Second anode lead 24 is made of a material identical to that of first anode lead 14. Second anode lead 24 includes second inner lead part 241 embedded in second anode 21 and second outer lead part 242 protruding from first end surface 211 of second anode 21. Second anode lead 24 has a wire shape with a circular shape in section orthogonal to first direction D1.

### (2.3) First Anode Terminal Plate, Second Anode Terminal Plate, First Cathode Terminal Plate, and Second Cathode Terminal Plate

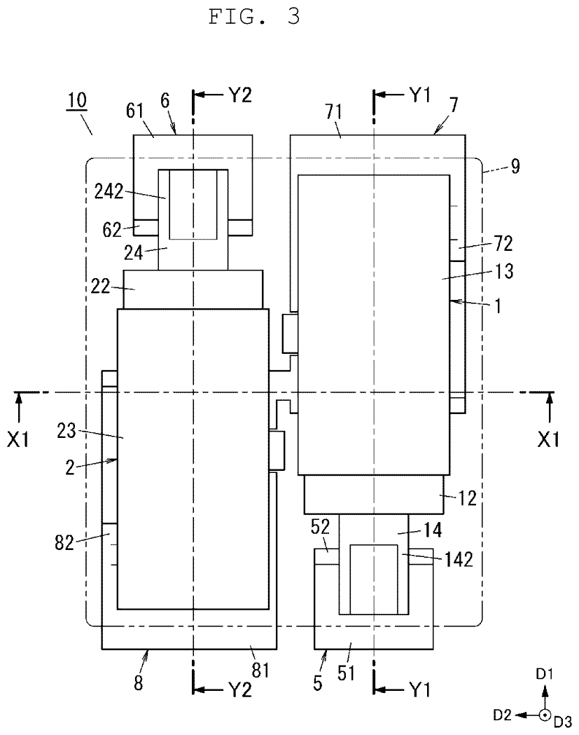

Examples of materials of first anode terminal plate 5, second anode terminal plate 6, first cathode terminal plate 7, and second cathode terminal plate 8 (see FIGS. 3 and 4) include copper and a copper alloy. First anode terminal plate 5, second anode terminal plate 6, first cathode terminal plate 7, and second cathode terminal plate 8 are equal in thickness to each other. First anode terminal plate 5, second anode terminal plate 6, first cathode terminal plate 7, and second cathode terminal plate 8 are formed of one lead frame, for example, but are not limited thereto.

Capacitor 10 includes first anode terminal plate 5 and first cathode terminal plate 7 that are disposed side by side in this order in first direction D1. Capacitor 10 also includes second cathode terminal plate 8 and second anode terminal plate 6 that are disposed side by side in this order in first direction D1. Capacitor 10 also includes first anode terminal plate 5 and second cathode terminal plate 8 that are disposed side by side in this order in second direction D2. Capacitor 10 also includes first cathode terminal plate 7 and second anode terminal plate 6 that are disposed side by side in this order in second direction D2.

First anode terminal plate 5 is connected to first outer lead part 142 of first anode lead 14. First anode terminal plate 5 has an L-shape, for example, and includes first anode terminal 51 disposed along lower surface 91 of resin part 9, and first rising part 52 protruding in third direction D3 from first anode terminal 51 toward first outer lead part 142 of first anode lead 14. First anode terminal 51 is exposed from lower surface 91 of resin part 9. First rising part 52 includes leading end 52a provided with first positioning groove 52b into which a part of first outer lead part 142 is inserted. First rising part 52 and first outer lead part 142 of first anode lead 14 are connected by welding, for example.

Second anode terminal plate 6 is connected to second outer lead part 242 of second anode lead 24. Second anode terminal plate 6 has an L-shape, for example, and includes second anode terminal 61 disposed along lower surface 91 of resin part 9, and second rising part 62 protruding in third direction D3 from second anode terminal 61 toward second outer lead part 242 of second anode lead 24. Second anode terminal 61 is exposed from lower surface 91 of resin part 9. Second rising part 62 includes leading end 62a provided with second positioning groove 62b into which a part of second outer lead part 242 is inserted. Second rising part 62 and second outer lead part 242 of second anode lead 24 are connected by welding, for example.

First cathode terminal plate 7 is electrically connected to first cathode 13 of first capacitor element 1. First cathode terminal plate 7 includes first cathode terminal 71, first mount part 72, and first protrusion 73.

First cathode terminal 71 is disposed along lower surface 91 of resin part 9, and is exposed from lower surface 91 of resin part 9. First cathode terminal 71 has a quadrangular shape in plan view, for example, but is not limited thereto.

First mount part 72 extends in a direction opposite to first direction D1 from a leading end of first stepped part 75 protruding obliquely upward from first cathode terminal 71. First mount part 72 is located between lower surface 91 of resin part 9 and first cathode 13 of first capacitor element 1 in third direction D3. First mount part 72 is separated from lower surface 91 of resin part 9 and first cathode 13 of first capacitor element 1. First mount part 72 has a quadrangular shape in plan view, for example. First mount part 72 is shorter in length in first direction D1 than first cathode 13 of first capacitor element 1. First mount part 72 overlaps first cathode 13 in third direction D3 orthogonal to first direction D1 and second direction D2, and is equipped with first capacitor element 1. Capacitor 10 further includes first junction (adhesive layer) 19 interposed between first cathode 13 of first capacitor element 1 and first mount part 72. First junction 19 has conductivity. First junction 19 contains metal (e.g., silver) and resin, for example. First junction 19 is formed using a conductive paste (e.g., silver paste), for example.

First protrusion 73 protrudes from first mount part 72 in third direction D3 and is located between first cathode 13 and second cathode 23. First protrusion 73 functions as a positioning part of first capacitor element 1 in second direction D2. First protrusion 73 is in contact with third side surface 133c of first cathode 13 of first capacitor element 1 in capacitor 10, but the present disclosure is not limited thereto, and first junction 19 may extend between first protrusion 73 and third side surface 133c of first cathode 13 of first capacitor element 1. First protrusion 73 and third side surface 233c of second cathode 23 of second capacitor element 2 are separated from each other in capacitor 10 and are not in contact with each other.

Second cathode terminal plate 8 is electrically connected to second cathode 23 of second capacitor element 2. Second cathode terminal plate 8 includes second cathode terminal 81, second mount part 82, and second protrusion 83.

Second cathode terminal 81 is disposed along lower surface 91 of resin part 9, and is exposed from lower surface 91 of resin part 9. Second cathode terminal 81 has a quadrangular shape in plan view, for example, but is not limited thereto.

Second mount part 82 extends in first direction D1 from a leading end of second stepped part 85 protruding obliquely upward from second cathode terminal portion 81. Second mount part 82 is located between lower surface 91 of resin part 9 and second cathode 23 of second capacitor element 2 in third direction D3. Second mount part 82 is separated from lower surface 91 of resin part 9 and second cathode 23 of second capacitor element 2. Second mount part 82 has a quadrangular shape in plan view, for example. Second mount part 82 is shorter in length in first direction D1 than second cathode 23 of second capacitor element 2. Second mount part 82 overlaps second cathode 23 in third direction D3, and is equipped with second capacitor element 2. Capacitor 10 further includes second junction (adhesive layer) 29 interposed between second cathode 23 of second capacitor element 2 and second mount part 82. Second junction 29 has conductivity. Second junction 29 contains metal (e.g., silver) and resin, for example. Second junction 29 is formed using a conductive paste (e.g., silver paste), for example.

Second protrusion 83 protrudes from second mount part 82 in third direction D3 and is located between second cathode 23 and first cathode 13. Second protrusion 83 functions as a positioning part of second capacitor element 2 in second direction D2. Second protrusion 83 is in contact with third side surface 233c of second cathode 23 of second capacitor element 2 in capacitor 10, but the present disclosure is not limited thereto, and second junction 29 may extend between second protrusion 83 and third side surface 233c of second cathode 23 of second capacitor element 2. Second protrusion 83 and third side surface 133c of first cathode 13 of first capacitor element 1 are separated from each other in capacitor 10 and are not in contact with each other.

Capacitor 10 includes first anode terminal 51, second anode terminal 61, first cathode terminal 71, and second cathode terminal 81, which have respective lower surfaces flush with each other.

Capacitor 10 according to the first exemplary embodiment includes first cathode terminal plate 7 and second cathode terminal plate 8 that are integrated. In other words, capacitor 10 according to the first exemplary embodiment includes first cathode terminal plate 7 and second cathode terminal plate 8 that are integrally formed with one conductive plate. That is, capacitor 10 according to the first exemplary embodiment includes first cathode terminal plate 7 and second cathode terminal plate 8 that are connected to each other without interposing a separate member therebetween.

First anode terminal plate 5 and second anode terminal plate 6 are disposed apart from each other, and are electrically insulated from each other.

### (2.4) Resin Part

As illustrated in FIGS. 6 to 8, resin part 9 is provided covering first capacitor element 1 and second capacitor element 2. Resin part 9 is provided covering first rising part 52 of first anode terminal plate 5, second rising part 62 of second anode terminal plate 6, first mount part 72 of first cathode terminal plate 7, first protrusion 73, second mount part 82 of second cathode terminal plate 8, and second protrusion 83.

Resin part 9 is a mold part having a substantially rectangular parallelepiped shape. Resin part 9 includes lower surface 91, upper surface 92, first side surface 93, second side surface 94, third side surface 95, and fourth side surface 96. Lower surface 91 and upper surface 92 of resin part 9 are located opposite to each other in third direction D3 as viewed from first capacitor element 1 and second capacitor element 2. Lower surface 91 and upper surface 92 of resin part 9 intersect third direction D3. First side surface 93 and second side surface 94 of resin part 9 are located opposite to each other in first direction D1 as viewed from first capacitor element 1 and second capacitor element 2. Third side surface 95 and fourth side surface 96 of resin part 9 are located opposite to each other in second direction D2 as viewed from first capacitor element 1 and second capacitor element 2. In consideration of mold releasability in a molding step of resin part 9, resin part 9 may include first side surface 93, second side surface 94, third side surface 95, and fourth side surface 96 each of which forms an angle less than 90 degrees with lower surface 91.

Resin part 9 exposes first anode terminal 51, second anode terminal 61, first cathode terminal 71, and second cathode terminal 81 on lower surface 91 of resin part 9.

Resin part 9 has electrical insulation. Resin part 9 is made of a material that contains resin (e.g., epoxy resin). Resin part 9 may contain a filler in addition to the resin. The resin is not limited to the epoxy resin, and may be phenol resin, a urea resin, polyimide, polyamideimide, polyurethane, diallyl phthalate, unsaturated polyester, polyphenylene sulfide (PPS), or polybutylene terephthalate (PBT), for example. Preferable examples of the filler include insulating particles and/or insulating fibers, and the like. Examples of the insulating material constituting the filler include insulating compounds (oxides and the like) such as silica and alumina, glass, and mineral materials (talc, mica, clay, etc.). Resin part 9 may contain one kind, or two or more kinds of filler, described above.

### (3) Method for Manufacturing Capacitor

After first capacitor element 1 and second capacitor element 2 are prepared, a first step, a second step, and a third step are sequentially performed. First anode 11, first dielectric layer 12, first solid electrolyte layer 15, first cathode 13, and first anode lead 14 of first capacitor element 1 are identical in material to second anode 21, second dielectric layer 22, second solid electrolyte layer 25, second cathode 23, and second anode lead 24 of second capacitor element 2, respectively. First anode 11, first dielectric layer 12, first solid electrolyte layer 15, first cathode 13, and first anode lead 14 of first capacitor element 1 are also equal in dimension to second anode 21, second dielectric layer 22, second solid electrolyte layer 25, second cathode 23, and second anode lead 24 of second capacitor element 2, respectively. Components of first capacitor element 1 identical in function to those of second capacitor element 2 have dimensions that are not limited to be exactly equal to those of second capacitor element 2, and the dimensions of the components of second capacitor element 2 may range from 90% to 110%, inclusive, of the dimensions of the components of first capacitor element 1.

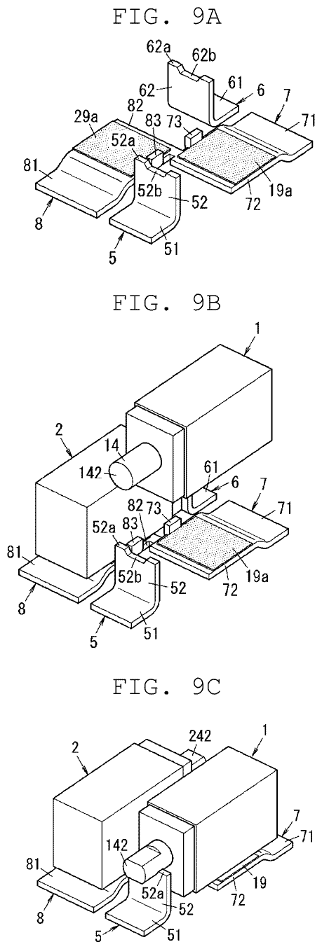

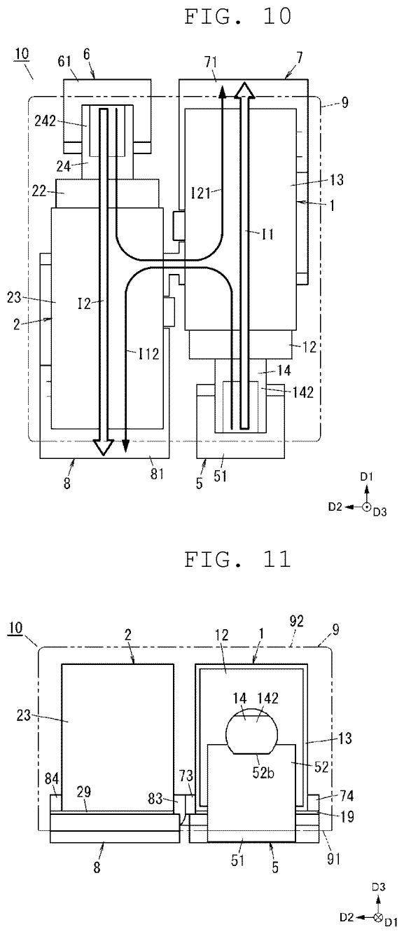

In the first step, conductive pastes 19a, 29a are applied to first mount part 72 of first cathode terminal plate 7 and second mount part 82 of second cathode terminal plate 8, respectively (see FIG. 9A).

In the second step, second outer lead part 242 of second anode lead 24 of second capacitor element 2 is placed in second positioning groove 62b at leading end 62a of second rising part 62 of second anode terminal plate 6, and second capacitor element 2 is placed on conductive paste 29a on second mount part 82 (see FIG. 9B). Then in the second step, first outer lead part 142 of first anode lead 14 of first capacitor element 1 is placed in first positioning groove 52b at leading end 52a of first rising part 52 of first anode terminal plate 5, and first capacitor element 1 is placed on conductive paste 19a on first mount part 72 (see FIG. 9B). Subsequently in the second step, first junction 19 is formed by curing conductive paste 19a, and second junction 29 is formed by curing conductive paste 29a.

In the third step, first outer lead part 142 and first rising part 52 of first anode terminal plate 5 are welded by bringing a welding electrode into contact with first outer lead part 142 to cause a current to flow while applying a predetermined pressing force from above (see FIG. 9C). As a result, first outer lead part 142 and first rising part 52 of first anode terminal plate 5 are mechanically and electrically connected. Then in the third step, second outer lead part 242 and second rising part 62 of second anode terminal plate 6 are welded by bringing a welding electrode into contact with second outer lead part 242 to cause a current to flow while applying a predetermined pressing force from above (see FIG. 9C). As a result, second outer lead part 242 and second rising part 62 of second anode terminal plate 6 are mechanically and electrically connected.

### (4) Conclusions

Capacitor 10 according to the first exemplary embodiment includes first capacitor element 1, second capacitor element 2, first anode terminal plate 5, second anode terminal plate 6, first cathode terminal plate 7, second cathode terminal plate 8, and resin part 9. First capacitor element 1 includes first anode 11, first dielectric layer 12, first cathode 13, and first anode lead 14. First anode 11 includes first end surface 111 and second end surface 112 that are separated from each other in first direction D1, and outer peripheral surface 113. First dielectric layer 12 covers first end surface 111, second end surface 112, and outer peripheral surface 113 of first anode 11. First cathode 13 covers first dielectric layer 12. First anode lead 14 includes first outer lead part 142 protruding from first end surface 111 of first anode 11. Second capacitor element 2 is adjacent to first capacitor element 1 in second direction D2 orthogonal to first direction D1. Second capacitor element 2 includes second anode 21, second dielectric layer 22, second cathode 23, and second anode lead 24. Second anode 21 includes first end surface 211 and second end surface 212 that are separated from each other in first direction D1, and outer peripheral surface 213. Second dielectric layer 22 covers first end surface 211, second end surface 212, and outer peripheral surface 213 of second anode 21. Second cathode 23 covers second dielectric layer 22. Second anode lead 24 includes second outer lead part 242 protruding from first end surface 211 of second anode 21. First anode terminal plate 5 includes first anode terminal 51. First anode terminal plate 5 is connected to first outer lead part 142. Second anode terminal plate 6 includes second anode terminal 61. Second anode terminal plate 6 is connected to second outer lead part 242. First cathode terminal plate 7 includes first cathode terminal 71. First cathode terminal plate 7 is connected to first cathode 13. Second cathode terminal plate 8 includes second cathode terminal 81. Second cathode terminal plate 8 is connected to second cathode 23. Resin part 9 covers first capacitor element 1 and second capacitor element 2. Resin part 9 exposes first anode terminal 51, second anode terminal 61, first cathode terminal 71, and second cathode terminal 81. In first capacitor element 1, first outer lead part 142 and first cathode 13 are disposed side by side in this order in first direction D1. In second capacitor element 2, second cathode 23 and second outer lead part 242 are disposed side by side in this order in first direction D1. First outer lead part 142 overlaps second cathode 23 at side view in second direction D2. Second outer lead part 242 overlaps first cathode 13 at the side view.

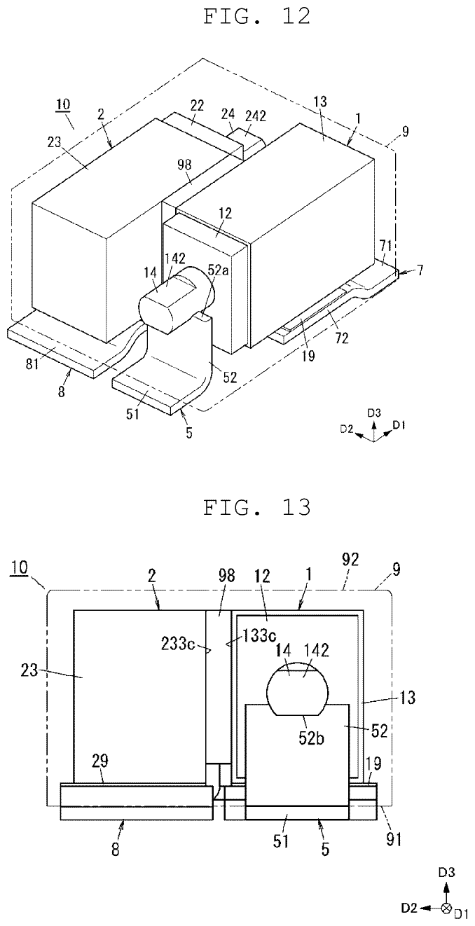

Capacitor 10 according to the first exemplary embodiment can achieve low equivalent series inductance (ESL) and downsizing. More specifically, capacitor 10 according to the first exemplary embodiment includes first capacitor element 1 in which first outer lead part 142 and first cathode 13 are disposed side by side in this order, and second capacitor element 2 in which second cathode 23 and second outer lead part 242 are disposed side by side in this order. As a result, capacitor 10 according to the first exemplary embodiment causes a direction in which a current flows from first cathode terminal 71 to first anode terminal 51 in first capacitor element 1 to be opposite to a direction in which a current flows from second cathode terminal 81 to second anode terminal 61 in second capacitor element 2. Thus, capacitor 10 according to the first exemplary embodiment causes a magnetic field generated by the current flowing through first capacitor element 1 and a magnetic field generated by the current flowing through second capacitor element 2 to be canceled out, so that magnetic flux generated in each of first capacitor element 1 and second capacitor element 2 is reduced. As a result, capacitor 10 according to the first exemplary embodiment can reduce equivalent series inductance (ESL), and thus can achieve low impedance. Capacitor 10 according to the first exemplary embodiment also causes first outer lead part 142 to overlap second cathode 23 at side view in second direction D2, and second outer lead part 242 to overlap first cathode 13 at the side view, so that a dead space where neither first capacitor element 1 nor second capacitor element 2 is disposed can be reduced to achieve downsizing. As a result, capacitor 10 according to the first exemplary embodiment can increase capacitance per unit volume of capacitor 10. Capacitor 10 according to the first exemplary embodiment enables not only a current path from first anode terminal 51 to second cathode terminal 81 to be formed, but also a current path from second anode terminal 61 to first cathode terminal 71 to be shortened, so that the ESL can be further reduced by simultaneously obtaining effects of shortening the respective current paths. FIG. 10 indicates current 112 flowing in the current path from first anode terminal 51 to second cathode terminal 81 and current I21 flowing in the current path from second anode terminal 61 to first cathode terminal 71 with respective arrows.

Capacitor 10 according to the first exemplary embodiment includes first anode terminal 51, first outer lead part 142, first cathode 13, and first cathode terminal 71 that are disposed side by side in this order in first direction D1. Capacitor 10 according to the first exemplary embodiment also includes second cathode terminal 81, second cathode 23, second outer lead part 242, and second anode terminal 61 that are disposed side by side in this order in first direction D1. As a result, capacitor 10 according to the first exemplary embodiment causes first current I1 to flow from first anode terminal 51 toward first cathode terminal 71 along first direction D1, and second current 12 to flow from second anode terminal 61 toward second cathode terminal 81 in a direction opposite to first direction D1 as illustrated in FIG. 10, so that an effect of canceling out a magnetic field generated by first current I1 and a magnetic field generated by second current 12 can be increased to further reduce the ESL.

Capacitor 10 according to the first exemplary embodiment includes first cathode terminal plate 7 and second cathode terminal plate 8 that are integrated, so that first capacitor element 1 and second capacitor element 2 can be connected in parallel by connecting first anode terminal 51 to second anode terminal 61 on a motherboard, for example.

Capacitor 10 according to the first exemplary embodiment includes first anode terminal 51 and second anode terminal 61 that are disposed along lower surface 91 of resin part 9. First anode terminal plate 5 includes first rising part 52 protruding from first anode terminal 51 toward first outer lead part 142, and second anode terminal plate 6 includes second rising part 62 protruding from second anode terminal 61 toward second outer lead part 242. First rising part 52 includes leading end 52a provided with first positioning groove 52b into which a part of first outer lead part 142 is inserted, and second rising part 62 includes leading end 62a provided with second positioning groove 62b into which a part of second outer lead part 242 is inserted. As a result, capacitor 10 according to the first exemplary embodiment enables each of first outer lead part 142 of first anode lead 14 and second outer lead part 242 of second anode lead 24 to be improved in positional accuracy to improve accuracy of the ESL.

Capacitor 10 according to the first exemplary embodiment includes first cathode terminal plate 7 including first protrusion 73 that enables first capacitor element 1 to be improved in positional accuracy, and second cathode terminal plate 8 including second protrusion 83 that enables second capacitor element 2 to be improved in positional accuracy. As a result, capacitor 10 according to the first exemplary embodiment enables not only reduction in variation in distance between first capacitor element 1 and second capacitor element 2 in second direction D2, but also increase in parallelism between first capacitor element 1 and second capacitor element 2, so that the ESL can be improved in accuracy.

### (5) Modification of First Exemplary Embodiment

### (5.1) First Modification

As illustrated in FIG. 11, capacitor 10 according to a first modification is different from capacitor 10 according to the first exemplary embodiment in that first cathode terminal plate 7 further includes third protrusion 74 and second cathode terminal plate 8 further includes fourth protrusion 84.

Third protrusion 74 protrudes from first mount part 72 in third direction D3, and faces first protrusion 73 across first capacitor element 1. Third protrusion 74 and first protrusion 73 face each other in second direction D2. Third protrusion 74 and first protrusion 73 function as two first positioning pieces that limit a placement range of first capacitor element 1 in second direction D2. Capacitor 10 according to the first modification may be configured such that third protrusion 74 is in contact with fourth side surface 133d of first cathode 13 of first capacitor element 1, or first junction 19 extends between third protrusion 74 and fourth side surface 133d of first cathode 13 of first capacitor element 1.

Fourth protrusion 84 protrudes from second mount part 82 in third direction D3, and faces second protrusion 83 across second capacitor element 2. Fourth protrusion 84 and second protrusion 83 face each other in second direction D2. Fourth protrusion 84 and second protrusion 83 function as two second positioning pieces that limit a placement range of second capacitor element 2 in second direction D2. Capacitor 10 according to the first modification may be configured such that fourth protrusion 84 is in contact with fourth side surface 233d of second cathode 23 of second capacitor element 2, or second junction 29 extends between fourth protrusion 84 and fourth side surface 233d of second cathode 23 of second capacitor element 2.

Capacitor 10 according to the first modification includes first cathode terminal plate 7 that further includes third protrusion 74 to enable first capacitor element 1 to be improved in positional accuracy in second direction D2. Capacitor 10 according to the first modification also includes second cathode terminal plate 8 that further includes fourth protrusion 84 to enable second capacitor element 2 to be improved in positional accuracy in second direction D2. Thus, capacitor 10 according to the first modification can improve accuracy of distance between first capacitor element 1 and second capacitor element 2 in second direction D2, so that the ESL can be improved in accuracy.

### (5.2) Second Modification

As illustrated in FIGS. 12 and 13, capacitor 10 according to a second modification is different from capacitor 10 according to the first exemplary embodiment in further including conductive part 98 disposed between first cathode 13 of first capacitor element 1 and second cathode 23 of second capacitor element 2. Conductive part 98 is disposed between third side surface 133c of first cathode 13 and third side surface 233c of second cathode 23. Conductive part 98 has conductivity. Conductive part 98 electrically connects first cathode 13 to second cathode 23. Conductive part 98 contains metal (e.g., silver) and resin, for example. Conductive part 98 is formed using a conductive paste (e.g., silver paste).

Capacitor 10 according to the second modification includes conductive part 98 to enable the ESL to be further reduced to further reduce impedance.

### (5.3) Third Modification

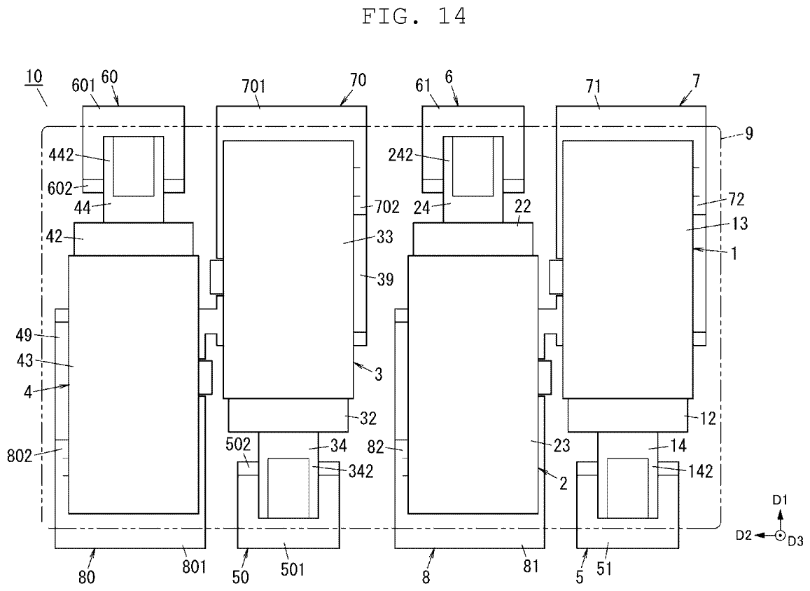

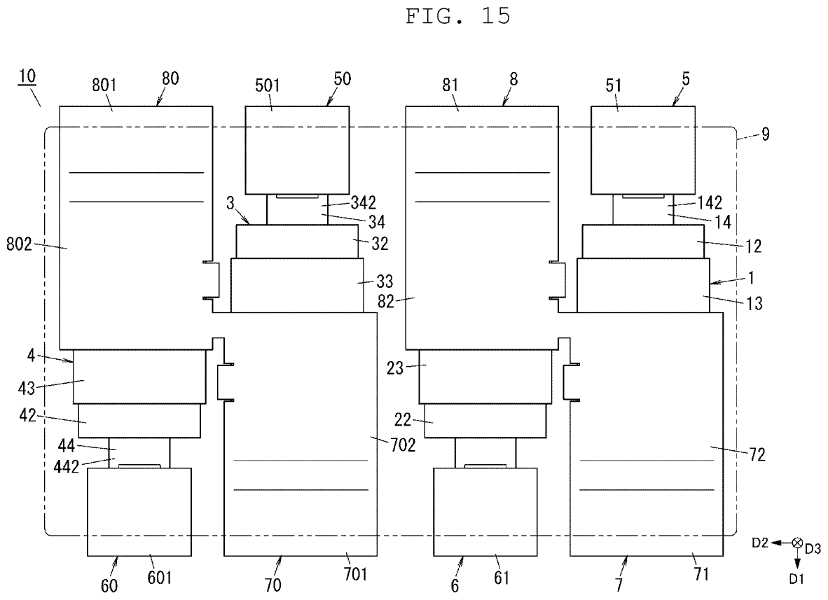

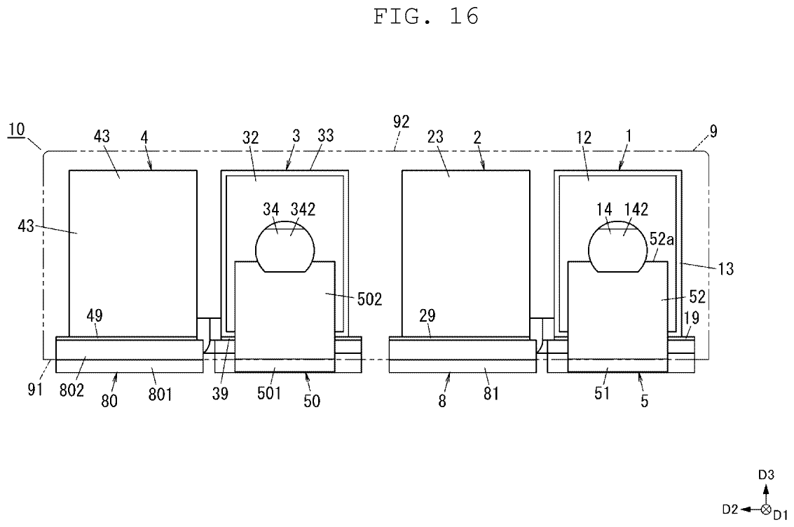

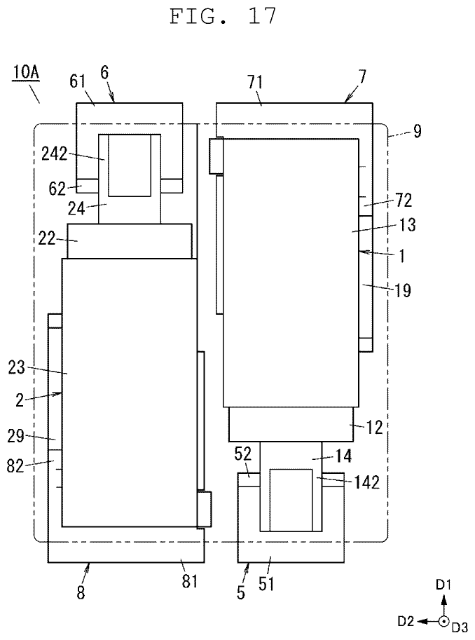

As illustrated in FIGS. 14 to 16, capacitor 10 according to a third modification is different from capacitor 10 according to the first exemplary embodiment in further including third capacitor element 3, fourth capacitor element 4, third anode terminal plate 50, fourth anode terminal plate 60, third cathode terminal plate 70, and fourth cathode terminal plate 80.

Capacitor 10 according to the third modification includes first capacitor element 1, second capacitor element 2, third capacitor element 3, and fourth capacitor element 4 that are disposed side by side in this order in second direction D2.

Third capacitor element 3 includes a third anode (not illustrated), third dielectric layer 32, a third solid electrolyte layer (not illustrated), third cathode 33, and third anode lead 34. Third anode 31, third dielectric layer 32, third solid electrolyte layer, third cathode 33, and third anode lead 34 of third capacitor element 3 are identical in material to first anode 11 (see FIGS. 6 and 8), first dielectric layer 12, first solid electrolyte layer 15, first cathode 13, and first anode lead 14 of first capacitor element 1, respectively. The third anode, third dielectric layer 32, the third solid electrolyte layer, third cathode 33, and third anode lead 34 of third capacitor element 3 are also equal in dimension to first anode 11, first dielectric layer 12, first solid electrolyte layer, first cathode 13, and first anode lead 14 of first capacitor element 1, respectively. Components of third capacitor element 3 identical in function to those of first capacitor element 1 have dimensions that are not limited to be exactly equal to those of first capacitor element 1, and the dimensions of the components of third capacitor element 3 may range from 90% to 110%, inclusive, of the dimensions of the components of first capacitor element 1.

Fourth capacitor element 4 includes a fourth anode (not illustrated), fourth dielectric layer 42, a fourth solid electrolyte layer (not illustrated), fourth cathode 43, and fourth anode lead 44. The fourth anode, fourth dielectric layer 42, the fourth solid electrolyte layer, fourth cathode 43, and fourth anode lead 44 of fourth capacitor element 4 are identical in material to first anode 11, first dielectric layer 12, first solid electrolyte layer 15, first cathode 13, and first anode lead 14 of first capacitor element 1, respectively. The fourth anode, fourth dielectric layer 42, the fourth solid electrolyte layer, fourth cathode 43, and fourth anode lead 44 of fourth capacitor element 4 are also equal in dimension to first anode 11, first dielectric layer 12, first solid electrolyte layer 15, first cathode 13, and first anode lead 14 of first capacitor element 1, respectively. Components of fourth capacitor element 4 identical in function to those of first capacitor element 1 have dimensions that are not limited to be exactly equal to those of first capacitor element 1, and the dimensions of the components of fourth capacitor element 4 may range from 90% to 110%, inclusive, of the dimensions of the components of first capacitor element 1.

Third anode terminal plate 50 includes third anode terminal 501 disposed along lower surface 91 of resin part 9, and third rising part 502 protruding from third anode terminal 501 in third direction D3 and being connected to third outer lead part 342 of third anode lead 34. Third anode terminal 501 and third rising part 502 of third anode terminal plate 50 are identical in shape to first anode terminal 51 and first rising part 52 of first anode terminal plate 5, respectively.

Fourth anode terminal plate 60 includes fourth anode terminal 601 disposed along lower surface 91 of resin part 9, and fourth rising part 602 protruding from fourth anode terminal 601 in third direction D3 and being connected to fourth outer lead part 442 of fourth anode lead 44. Fourth anode terminal 601 and fourth rising part 602 of fourth anode terminal plate 60 are identical in shape to second anode terminal 61 and second rising part 62 of second anode terminal plate 6, respectively.

Third cathode terminal plate 70 includes third cathode terminal 701 disposed along lower surface 91 of resin part 9, and third mount part 702 to which third cathode 33 of third capacitor element 3 is joined with third junction 39 interposed therebetween.

Fourth cathode terminal plate 80 includes fourth cathode terminal 801 disposed along lower surface 91 of resin part 9, and fourth mount part 802 to which fourth cathode 43 of fourth capacitor element 4 is joined with fourth junction 49 interposed therebetween.

Capacitor 10 according to the third modification includes resin part 9 covering first capacitor element 1, second capacitor element 2, third capacitor element 3, and fourth capacitor element 4. Resin part 9 is also provided covering first rising part 52 of first anode terminal plate 5, second rising part 62 of second anode terminal plate 6, third rising part 502 of third anode terminal plate 50, fourth rising part 602 of fourth anode terminal plate 60, first mount part 72 of first cathode terminal plate 7, second mount part 82 of second cathode terminal plate 8, third mount part 702 of third cathode terminal plate 70, and fourth mount part 802 of fourth cathode terminal plate 80.

Resin part 9 includes lower surface 91 that exposes first anode terminal 51, second anode terminal 61, third anode terminal 501, fourth anode terminal 601, first cathode terminal 71, second cathode terminal 81, third cathode terminal 701, and fourth cathode terminal 801.

In third capacitor element 3, third outer lead part 342 and third cathode 33 are disposed side by side in this order in first direction D1. In fourth capacitor element 4, fourth cathode 43 and fourth outer lead part 442 are disposed side by side in this order in first direction D1. Third outer lead part 342 overlaps fourth cathode 43 at side view in second direction D2. Fourth outer lead part 442 overlaps third cathode 33 in the side view.

Capacitor 10 according to the third modification includes first cathode terminal plate 7 and second cathode terminal plate 8 that are integrated, so that first capacitor element 1 and second capacitor element 2 can be connected in parallel by connecting first anode terminal 51 to second anode terminal 61 on a motherboard, for example. Capacitor 10 according to the third modification also includes third cathode terminal plate 70 and fourth cathode terminal plate 80 that are integrated, so that third capacitor element 3 and fourth capacitor element 4 can be connected in parallel by connecting third anode terminal 501 to fourth anode terminal 601 on a motherboard, for example.

### Second Exemplary Embodiment

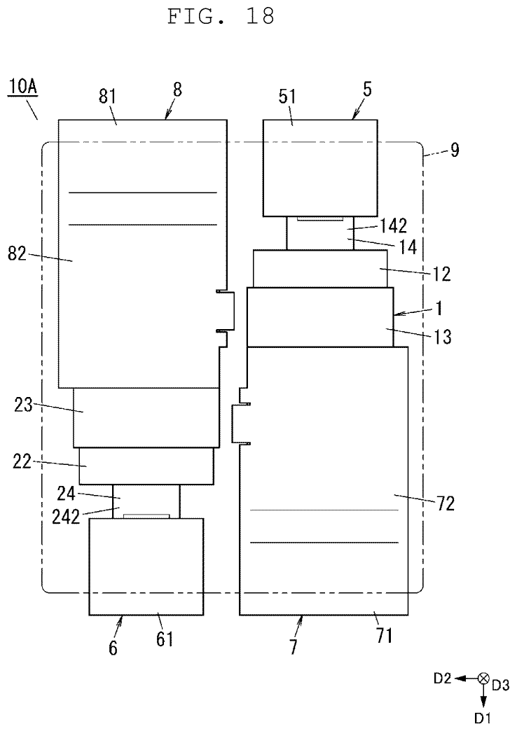

Capacitor 10A according to a second exemplary embodiment will be described with reference to FIGS. 17 and 18. Capacitor 10A according to the second exemplary embodiment includes a component similar to that of capacitor 10 (see FIGS. 1 to 8) according to the first exemplary embodiment, the component being denoted by the same reference numeral as in capacitor 10 to eliminate description thereof.

Capacitor 10A according to the second exemplary embodiment includes second cathode terminal plate 8 that is a conductive plate separate from first cathode terminal plate 7. Although capacitor 10A according to the second exemplary embodiment also includes first anode terminal plate 5, second anode terminal plate 6, first cathode terminal plate 7, and second cathode terminal plate 8, which are formed of one lead frame, for example, the present disclosure is not limited thereto.

Capacitor 10A includes second mount part 82 of second cathode terminal plate 8 and first mount part 72 of first cathode terminal plate 7 that are separated from each other in second direction D2, and a part of resin part 9 is interposed between second mount part 82 and first mount part 72. Thus, capacitor 10A includes first cathode terminal plate 7 and second cathode terminal plate 8 that are electrically insulated from each other.

When capacitor 10A according to the second exemplary embodiment is used by being mounted on a motherboard, for example, a user can select whether to use the capacitor in a first mode in which first cathode terminal plate 7 and second cathode terminal plate 8 are connected on the motherboard or in a second mode in which first cathode terminal plate 7 and second cathode terminal plate 8 are not connected on the motherboard.

### Third Exemplary Embodiment

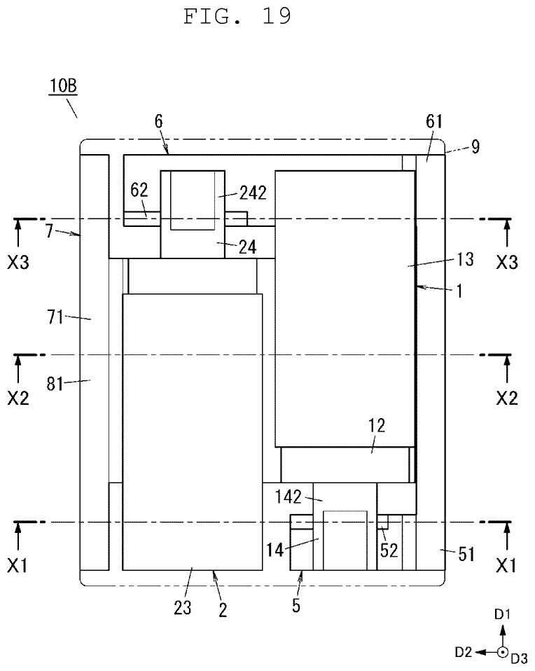

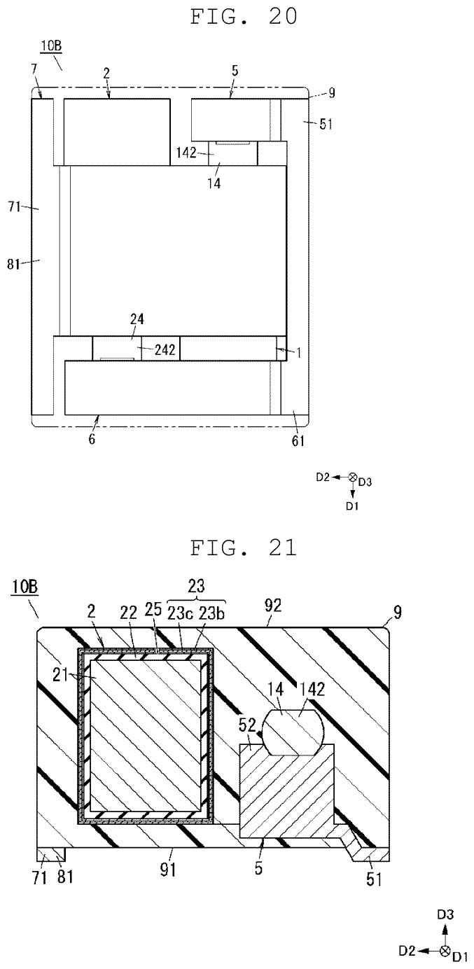

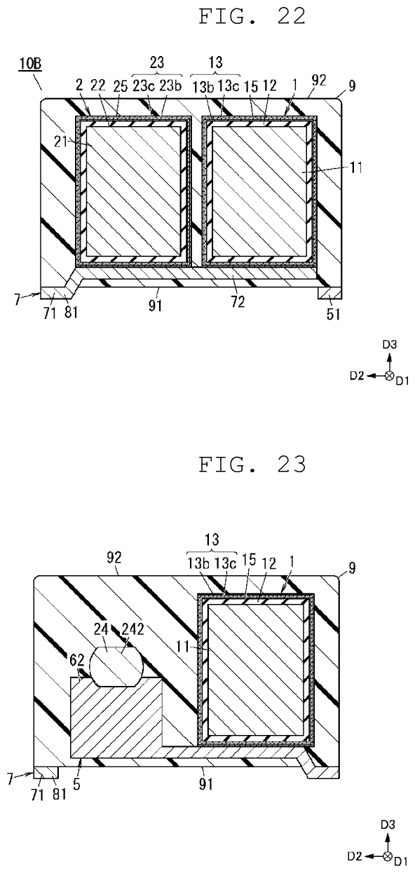

Capacitor 10B according to a third exemplary embodiment will be described with reference to FIGS. 19 to 23. Capacitor 10B according to the third exemplary embodiment includes a component similar to that of capacitor 10 (see FIGS. 1 to 8) according to the first exemplary embodiment, the component being denoted by the same reference numeral as in capacitor 10 to eliminate description thereof.

Capacitor 10B includes first anode terminal plate 5 and second anode terminal plate 6 that are integrated, and first cathode terminal plate 7 and second cathode terminal plate 8 that are integrated.

Capacitor 10B includes first anode terminal 51 of first anode terminal plate 5 and second anode terminal 61 of second anode terminal plate 6 that are composed of one anode terminal, and first cathode terminal 71 of first cathode terminal plate 7 and second cathode terminal 81 of second cathode terminal plate 8 that are composed of one cathode terminal. Thus, capacitor 10B includes first anode terminal 51 and second anode terminal 61 that constitute a common anode terminal, and first cathode terminal 71 and second cathode terminal 81 that constitute a common cathode terminal. Capacitor 10B includes first rising part 52 and second rising part 62 that are connected by one anode terminal. Capacitor 10B includes second cathode terminal 81 that also serves as first cathode terminal 71. Thus, capacitor 10B constitutes a two-terminal structure capacitor including one anode terminal and one cathode terminal as a plurality of external terminals to be mounted on a circuit board such as a motherboard.

Capacitor 10B includes one anode terminal and one cathode terminal that are located apart from each other in second direction D2. In first direction D1, the one anode terminal has an equal length to the one cathode terminal.

Capacitor 10B according to the third exemplary embodiment includes first outer lead part 142 and first cathode 13 of first capacitor element 1 that are disposed side by side in this order in first direction D1, and second cathode 23 and second outer lead part 242 of second capacitor element 2 that are disposed side by side in this order in first direction D1. As a result, capacitor 10B according to the third exemplary embodiment causes a direction in which a current flows from first cathode terminal 71 to first anode terminal 51 in first capacitor element 1 to be opposite to a direction in which a current flows from second cathode terminal 81 to second anode terminal 61 in second capacitor element 2. Thus, capacitor 10B according to the third exemplary embodiment causes a magnetic field generated by the current flowing through first capacitor element 1 and a magnetic field generated by the current flowing through second capacitor element 2 to be canceled out, so that magnetic flux generated in each of first capacitor element 1 and second capacitor element 2 is reduced. As a result, capacitor 10B according to the third exemplary embodiment can reduce the ESL to achieve low impedance. Capacitor 10B according to the third exemplary embodiment also causes first outer lead part 142 to overlap second cathode 23 at side view in second direction D2, and second outer lead part 242 to overlap first cathode 13 at the side view, so that a dead space where neither first capacitor element 1 nor second capacitor element 2 is disposed can be reduced to achieve downsizing. As a result, capacitor 10B according to the third exemplary embodiment can increase capacitance per unit volume of capacitor 10B.

Capacitor 10B according to the third exemplary embodiment also has a two-terminal structure as with a general-purpose capacitor, in which first capacitor element 1 and second capacitor element 2 are connected in parallel, and thus can improve usability.

### Other Modifications

The first to third exemplary embodiments described above are each merely one of various exemplary embodiments of the present disclosure. The first to third exemplary embodiments described above can be variously changed according to design and the like as long as the object of the present disclosure can be achieved.

For example, capacitor 10 according to the first exemplary embodiment may include first anode terminal plate 5, second anode terminal plate 6, first cathode terminal plate 7, and second cathode terminal plate 8, which are different in shape from each other.

For example, another example of capacitor 10 according to the first exemplary embodiment may include a part connecting first cathode terminal plate 7 and second cathode terminal plate 8, the part being integrated with first cathode terminal plate 7 and second cathode terminal plate 8, and the part, first cathode terminal plate 7, and second cathode terminal plate 8 being formed of one lead frame.

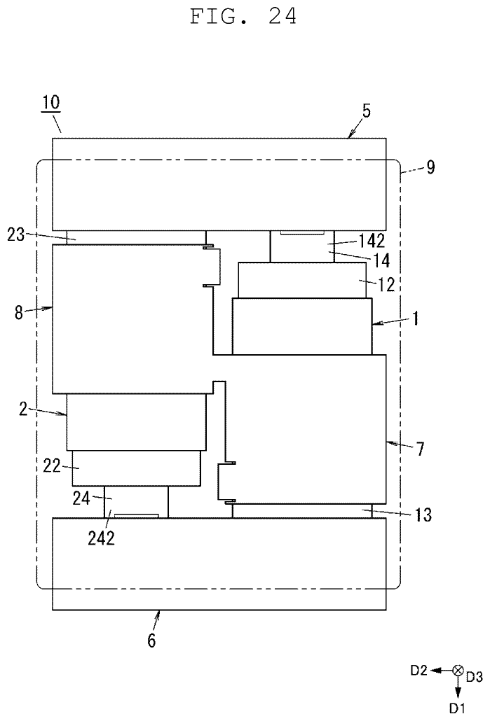

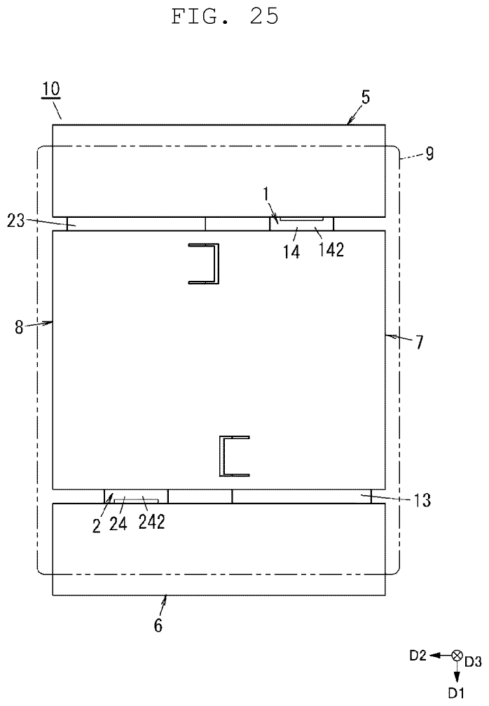

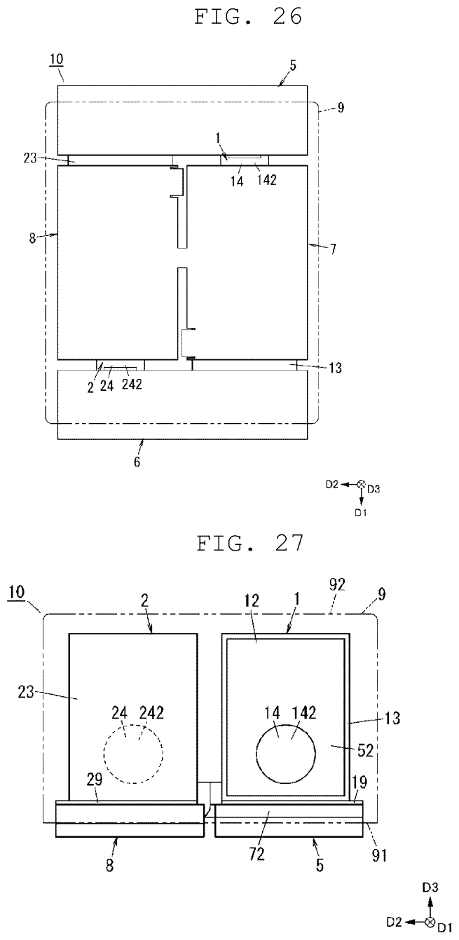

As in any of the fourth, fifth, and sixth modifications illustrated in FIGS. 24, 25, and 26, respectively, each of first anode terminal plate 5 and second anode terminal plate 6 may have a shape overlapping both first capacitor element 1 and second capacitor element 2 at plan view in third direction D3. FIGS. 24 to 26 each illustrate first anode terminal plate 5 and second anode terminal plate 6 that can be reduced in impedance. Capacitor 10 according to the fifth modification illustrated in FIG. 25 includes first cathode terminal plate 7 and second cathode terminal plate 8 each of which has a length in first direction D1 that is longer than a length of each of first cathode terminal plate 7 and second cathode terminal plate 8 in first direction D1 in capacitor 10 according to the fourth modification illustrated in FIG. 24, so that impedance between first cathode terminal plate 7 and second cathode terminal plate 8 can be reduced. Each of capacitor 10 according to the fifth modification illustrated in FIG. 25 and capacitor 10 according to the sixth modification illustrated in FIG. 26 has a shape in which first cathode terminal plate 7 and second cathode terminal plate 8 are line-symmetric with respect to a center line orthogonal to second direction D2. FIGS. 24 to 26 each illustrate first cathode terminal plate 7 in a shape before a part to be first protrusion 73 is bent, and second cathode terminal plate 8 in a state before a part to be second protrusion 83 is bent.

First anode terminal plate 5 may have a shape without first rising part 52. In this case, a first connection member that connects first anode terminal 51 of first anode terminal plate 5 to first outer lead part 142 may be provided, for example. The first connection member has conductivity. The first connection member may be formed using a conductive paste, or may be a first metal plate joined to first anode terminal 51, for example.

Second anode terminal plate 6 may have a shape without second rising part 62. In this case, a second connection member that connects second anode terminal 61 of second anode terminal plate 6 to second outer lead part 242 may be provided, for example. The second connection member has conductivity. The second connection member may be formed using a conductive paste, or may be a second metal plate joined to second anode terminal 61, for example.

Although capacitor 10 according to the first exemplary embodiment includes first outer lead part 142 located at the center of first capacitor element 1 in third direction D3, and second outer lead part 242 located at the center of second capacitor element 2 in third direction D3, the present disclosure is not limited thereto. For example, first outer lead part 142 may be located at a lower end of first capacitor element 1 in third direction D3, and second outer lead part 242 may be located at a lower end of second capacitor element 2 in third direction D3, as in capacitor 10 according to a seventh modification illustrated in FIG. 27. When capacitor 10 according to the seventh modification is used by being mounted on a circuit board such as a motherboard, for example, a distance between first outer lead part 142 and the circuit board, and a distance between second outer lead part 242 and the circuit board, can be reduced shorter than those in the first exemplary embodiment, so that the current path can be shortened to further reduce the ESL.

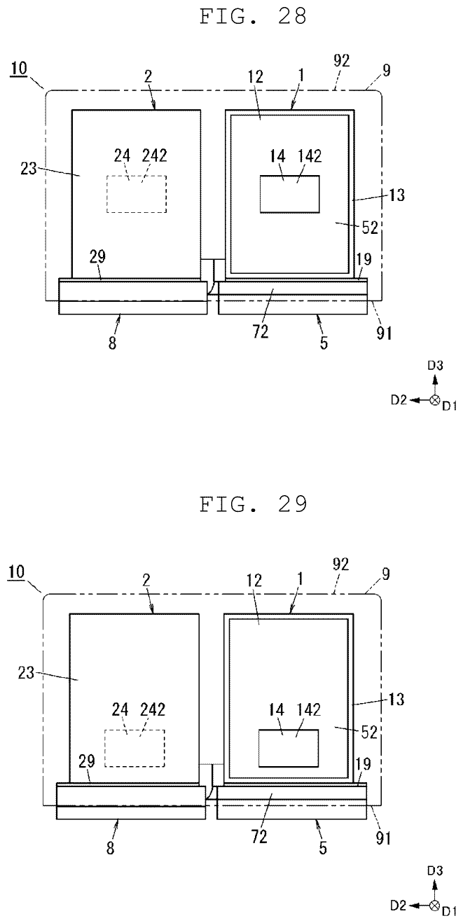

As in capacitor 10 according to an eighth modification illustrated in FIG. 28 and capacitor 10 according to a ninth modification illustrated in FIG. 29, each of first outer lead part 142 and second outer lead part 242 may have a quadrangular shape in front view in first direction D1. In other words, each of first anode lead 14 and second anode lead 24 is not limited to a wire shape, and may have a plate shape, a foil shape, or a quadrangular prismatic shape.

Capacitor 10 according to the first exemplary embodiment includes first cathode terminal plate 7 that includes first protrusion 73. However, the present disclosure is not limited thereto, and first cathode terminal plate 7 may be configured without first protrusion 73, or first protrusion 73 formed of a member different from first cathode terminal plate 7 may be fixed to first cathode terminal plate 7. Second cathode terminal plate 8 includes second protrusion 83. However, the present disclosure is not limited thereto, and second cathode terminal plate 8 may be configured without second protrusion 83, or second protrusion 83 formed of a member different from second cathode terminal plate 8 may be fixed to second cathode terminal plate 8.

### Aspects

According to the first to third exemplary embodiments and the like described above, the following aspects are disclosed herein.

Capacitor (10; 10A; 10B) according to a first aspect includes first capacitor element (1), second capacitor element (2), first anode terminal plate (5), second anode terminal plate (6), first cathode terminal plate (7), second cathode terminal plate (8), and resin part (9). First capacitor element (1) includes first anode (11), first dielectric layer (12), first cathode (13), and first anode lead (14). First anode (11) includes first end surface (111) and second end surface (112) that are separated from each other in first direction (D1), and outer peripheral surface (113). First dielectric layer (12) covers first end surface (111) of first anode (11), second end surface (112) of first anode (11), and outer peripheral surface (113) of first anode (11). First cathode (13) covers first dielectric layer (12). First anode lead (14) includes first outer lead part (142) protruding from first end surface (111) of first anode (11). Second capacitor element (2) is adjacent to first capacitor element (1) in second direction (D2) orthogonal to first direction (D1). Second capacitor element (2) includes second anode (21), second dielectric layer (22), second cathode (23), and second anode lead (24). Second anode (21) includes first end surface (211) and second end surface (212) that are separated from each other in first direction (D1), and outer peripheral surface (213). Second dielectric layer (22) covers first end surface (211) of second anode (21), second end surface (212) of second anode (21), and outer peripheral surface (213) of second anode (21). Second cathode (23) covers second dielectric layer (22). Second anode lead (24) includes second outer lead part (242) protruding from first end surface (211) of second anode (21). First anode terminal plate (5) includes first anode terminal (51). First anode terminal plate (5) is connected to first outer lead part (142). Second anode terminal plate (6) includes second anode terminal (61). Second anode terminal plate (6) is connected to second outer lead part (242). First cathode terminal plate (7) includes first cathode terminal (71). First cathode terminal plate (7) is connected to first cathode (13). Second cathode terminal plate (8) includes second cathode terminal (81). Second cathode terminal plate (8) is connected to second cathode (23). Resin part (9) covers first capacitor element (1) and second capacitor element (2). Resin part (9) exposes first anode terminal (51), second anode terminal (61), first cathode terminal (71), and second cathode terminal (81). In first capacitor element (1), first outer lead part (142) and first cathode (13) are disposed side by side in this order in first direction (D1). In second capacitor element (2), second cathode (23) and second outer lead part (242) are disposed side by side in this order in first direction (D1). First outer lead part (142) overlaps second cathode (23) at side view in second direction (D2). Second outer lead part (242) overlaps first cathode (13) at the side view.

This aspect enables a low ESL and downsizing.

In the first aspect, capacitor (10; 10B) according to a second aspect includes first cathode terminal plate (7) and second cathode terminal plate (8) that are integrated.

This aspect enables first capacitor element (1) and second capacitor element (2) to be connected in parallel by connecting first anode terminal (51) and second anode terminal (61).

In the second aspect, capacitor (10) according to a third aspect further includes conductive part (98). Conductive part (98) is disposed between first cathode (13) and second cathode (23), conductive part (98) connecting first cathode (13) and second cathode (23).

This aspect enables further reduction in ESL and further reduction in impedance.

In the first aspect, capacitor (10A) according to a fourth aspect includes second cathode terminal plate (8) that is a conductive plate separate from first cathode terminal plate (7).

When capacitor (10A) is used by being mounted on a motherboard, for example, this aspect enables a user to select whether to use the capacitor in a first mode in which first cathode terminal plate (7) and second cathode terminal plate (8) are connected on the motherboard or in a second mode in which first cathode terminal plate (7) and second cathode terminal plate (8) are not connected on the motherboard.

In any one of the first to fourth aspects, capacitor (10; 10A; 10B) according to a fifth aspect includes resin part (9) including lower surface (91) and upper surface (92) that intersect third direction (D3) orthogonal to first direction (D1) and second direction (D2). First anode terminal (51) and second anode terminal (61) are disposed along lower surface (91) of resin part (9). First anode terminal plate (5) includes first rising part (52) protruding from first anode terminal (51) in third direction (D3). First rising part (52) includes leading end (52a) provided with first positioning groove (52b) into which a part of first outer lead part (142) is inserted. Second anode terminal plate (6) includes second rising part (62) protruding from second anode terminal (61) in third direction (D3). Second rising part (62) includes leading end (62a) provided with second positioning groove (62b) into which a part of second outer lead part (242) is inserted.

This aspect enables each of first outer lead part (142) of first anode lead (14) and second outer lead part (242) of second anode lead (24) to be improved in positional accuracy to improve accuracy of the ESL.

Capacitor (10; 10A) according to a sixth aspect is based on any one of the first to fifth aspects. First anode terminal (51), first outer lead part (142), first cathode (13), and first cathode terminal (71) are disposed side by side in this order in first direction (D1). Second cathode terminal (81), second cathode (23), second outer lead part (242), and second anode terminal (61) are disposed side by side in this order in first direction (D1). This aspect causes first current (11) to flow from first anode terminal (51) toward first cathode terminal (71) along first direction (D1), and second current (12) to flow from second anode terminal (61) toward second cathode terminal (81) in a direction opposite to first direction (D1), so that an effect of canceling out a magnetic field generated by first current (11) and a magnetic field generated by second current (12) can be increased to further reduce the ESL.

In any one of the first to sixth aspects, capacitor (10; 10A; 10B) according to a seventh aspect includes first cathode terminal plate (7) that further includes first mount part (72) and first protrusion (73). First mount part (72) overlaps first cathode (13) in third direction (D3) orthogonal to first direction (D1) and second direction (D2), and is equipped with first capacitor element (1). First protrusion (73) protrudes from first mount part (72) in third direction (D3) and is located between first cathode (13) and second cathode (23). Second cathode terminal plate (8) further includes second mount part (82) and second protrusion (83). Second mount part (82) overlaps second cathode (23) in third direction (D3), and is equipped with second capacitor element (2). Second protrusion (83) protrudes from second mount part (82) in third direction (D3) and is located between first cathode (13) and second cathode (23).

This aspect enables not only reduction in variation in distance between first capacitor element (1) and second capacitor element (2) in second direction (D2), but also increase in parallelism between first capacitor element (1) and second capacitor element (2), so that the ESL can be improved in accuracy.

### REFERENCE MARKS IN THE DRAWINGS

1 first capacitor element
11 first anode
111 first end surface
112 second end surface
113 outer peripheral surface
12 first dielectric layer
13 first cathode
14 first anode lead
141 first inner lead part
142 first outer lead part
15 first solid electrolyte layer
2 second capacitor element
21 second anode
211 first end surface
212 second end surface
213 outer peripheral surface
22 second dielectric layer
23 second cathode
24 second anode lead
241 second inner lead part
242 second outer lead part
25 second solid electrolyte layer
3 third capacitor element
4 fourth capacitor element
5 first anode terminal plate
51 first anode terminal
52 first rising part
52a leading end
52b first positioning groove
6 second anode terminal plate
61 second anode terminal
62 second rising part
62a leading end
62b second positioning groove
7 first cathode terminal plate
71 first cathode terminal
72 first mount part
73 first protrusion
74 third protrusion
8 second cathode terminal plate
81 second cathode terminal
82 second mount part
83 second protrusion
84 fourth protrusion
9 resin part
91 lower surface
92 upper surface
98 conductive part
10, 10A, 10B capacitor
D1 first direction
D2 second direction
D3 third direction
I1 first current
12 second current

1. A capacitor comprising:
a first capacitor element including:
a first anode including a first end surface and a second end surface that are separated from each other in a first direction, and an outer peripheral surface;
a first dielectric layer covering the first end surface of the first anode, the second end surface of the first anode, and the outer peripheral surface of the first anode;
a first cathode covering the first dielectric layer; and
a first anode lead including a first outer lead part protruding from the first end surface of the first anode;
a second capacitor element adjacent to the first capacitor element in a second direction orthogonal to the first direction, the second capacitor element including:
a second anode including a first end surface and a second end surface that are separated from each other in the first direction, and an outer peripheral surface;
a second dielectric layer covering the first end surface of the second anode, the second end surface of the second anode, and the outer peripheral surface of the second anode;
a second cathode covering the second dielectric layer; and
a second anode lead including a second outer lead part protruding from the first end surface of the second anode;
a first anode terminal plate including a first anode terminal and being connected to the first outer lead part;
a second anode terminal plate including a second anode terminal and being connected to the second outer lead part;
a first cathode terminal plate including a first cathode terminal and being connected to the first cathode;
a second cathode terminal plate including a second cathode terminal and being connected to the second cathode; and
a resin part covering the first capacitor element and the second capacitor element and exposing the first anode terminal, the second anode terminal, the first cathode terminal, and the second cathode terminal, wherein:
in the first capacitor element, the first outer lead part and the first cathode are disposed side by side in this order in the first direction,
in the second capacitor element, the second cathode and the second outer lead part are disposed side by side in this order in the first direction,
the first outer lead part overlapping the second cathode at side view in the second direction, and
the second outer lead part overlapping the first cathode at the side view.

2. The capacitor according to claim 1, wherein the first cathode terminal plate and the second cathode terminal plate are integrated.

3. The capacitor according to claim 2, further comprising a conductive part disposed between the first cathode and the second cathode, the conductive part connecting the first cathode and the second cathode.

4. The capacitor according to claim 1, wherein the second cathode terminal plate is a conductive plate separate from the first cathode terminal plate.

5. The capacitor according to Claim 1, wherein:
the resin part includes a lower surface and an upper surface intersecting a third direction orthogonal to the first direction and the second direction,
the first anode terminal and the second anode terminal are disposed along the lower surface of the resin part,
the first anode terminal plate includes a first rising part protruding from the first anode terminal in the third direction,
the first rising part includes a leading end provided with a first positioning groove into which a part of the first outer lead part is inserted,
the second anode terminal plate includes a second rising part protruding from the second anode terminal in the third direction, and
the second rising part includes a leading end provided with a second positioning groove into which a part of the second outer lead part is inserted.

6. The capacitor according to Claim 1, wherein:
the first anode terminal, the first outer lead part, the first cathode, and the first cathode terminal are disposed side by side in this order in the first direction, and
the second cathode terminal, the second cathode, the second outer lead part, and the second anode terminal are disposed side by side in this order in the first direction.

7. The capacitor according to Claim 1, wherein:
the first cathode terminal plate further includes:
a first mount part that overlaps the first cathode in the third direction orthogonal to the first direction and the second direction, and is equipped with the first capacitor element; and
a first protrusion that protrudes from the first mount part in the third direction and is located between the first cathode and the second cathode, and
the second cathode terminal plate further includes:
a second mount part that overlaps the second cathode in the third direction and is equipped with the second capacitor element; and
a second protrusion that protrudes from the second mount part in the third direction and is located between the first cathode and the second cathode.
